(19) United States
(12) Patent Application Publication
(10) Pub. No.: US 2003/0038105 A1
(43) Pub. Date: Feb. 27, 2003

(54) Tool for embossing high aspect ratio microstructures

(76) Inventors: Alan B. Harker, Thousand Oaks, CA (US); Jeffrey F. DeNatale, Thousand Oaks, CA (US); Dennis Strauss, Ventura, CA (US)

Correspondence Address: Mark D. Elchuk, Harness Dickey & Pierce P.L.C., P.O. Box 828, Bloomfield Hills, MI, 48303, US

(21) Appl. No.: 09/940,223

(22) Filed: Aug. 27, 2001

(51) Int. Cl. B41N 3/00

(52) U.S. Cl. 216/2; 216/8; 216/9; 216/11; 216/67; 216/79; 216/99

(57) ABSTRACT

A tool for embossing high aspect ratio microstructures is provided, wherein the microstructures provide decreased surface reflection and increased transmission through an optical component. The tool is fabricated by a process that comprises etching columnar pits in a silicon substrate using inductively coupled plasma, followed by reactive ion etching of the columnar pits to create relatively pointed obelisks. The silicon substrate is then preferably rinsed prior to vapor depositing a conductive layer thereon. Finally, a metal is electroformed over the conductive layer to form the embossing tool. The embossing tool is then pressed against an optical coating, for example a polymer sheet, to create microstructures having aspect ratios greater than 5 to 1.

### CROSS-REFERENCE TO RELATED APPLICATIONS

This application discloses subject matter that is disclosed and claimed in co-pending United States patent application entitled “Process For Fabricating High Aspect Ratio Embossing Tool and Microstructures” in the names of Alan B. Harker, Jeffrey F. DeNatale, and Dennis Strauss, filed (Date), Attorney Docket No. 7784-000254, the entire contents of which are incorporated herein by reference.

### FIELD OF THE INVENTION

The present invention relates generally to optical coatings that are used to control optical performance and more particularly to embossing tools for fabrication of high aspect ratio microstructures in optical coatings.

### BACKGROUND OF THE INVENTION

Optical coatings are typically employed in applications where surface reflections must be minimized in either or both the infrared (IR) and visible wavelength regions. The optical coatings generally comprise microstructures that form a dense array of microscopic features, which exhibit little or no diffraction or scattering of the incident light. Generally, the dimensions and spacing of the microscopic features are smaller than the shortest wavelength of incident light in a particular wavelength region and further provide a gradual transition in the effective index of refraction, i.e. a graded index of refraction. Further, such microstructures are often referred to as having “moth-eye” surfaces because it has been observed that the eyes of moths reflect almost no light.

The aspect ratio of the microscopic features is preferably high in order to provide adequate reflections at high incidence angles. In one known microstructure, an aspect ratio of greater than 3 to 1 results in reduced surface reflection and increased transmission through an optical component at incidence angles greater than 75 degrees. Unfortunately, fabrication of such microstructures is relatively complicated, and less complicated fabrication techniques such as standard micro-lithography have been incapable of producing the high aspect ratio microstructures. Additionally, known fabrication methods generally do not provide for a graded index of refraction, which is often required to provide adequate reflection for the incident light.

For example, U.S. Pat. No. 5,334,342 to Harker et al., the contents of which are incorporated herein by reference in their entirety, discloses a method of fabricating a diamond moth-eye surface wherein a polycrystalline diamond thin film is deposited on a substrate using micro-lithographic techniques. Generally, the moth-eye geometry is formed on relatively thick substrate materials rather than on a thin coating, and the geometry is formed on the substrate using a series of micro-lithographic patterning techniques, which may include dry and/or wet etching techniques. The diamond coating is then bonded to a substrate, preferably using a glass layer such as a low-temperature, refractive index-matched Chalcogenide glass.

Further, U.S. Pat. No. 5,629,074 to Klocek et al. discloses a method of embossing a pattern into a sheet of polymeric material, however, the pattern is created using a mold that is formed using a conventional diamond lathe. Unfortunately, the conventional diamond lathe cannot produce relatively high aspect ratio patterns, and as a result, low reflectivity at high incidence angles may not be possible.

Accordingly, there remains a need in the art for a relatively low cost process of forming high aspect ratio moth-eye microstructures using standard etching procedures. The process should further be capable of producing high aspect ratio moth-eye microstructures that provide a graded index of refraction and low reflectivity at high incidence angles in both the visible and infrared wavelength regions.

### SUMMARY OF THE INVENTION

In one preferred form, the present invention provides an embossing tool that comprises high aspect ratio moth-eye microstructures, hereinafter referred to as etch features. The embossing tool is then used to produce a high aspect ratio microstructure in an optical coating such as a polymer sheet by pressing the embossing tool against the surface of the optical coating. Accordingly, a high aspect ratio microstructure is created in the coating, which is a negative image of the etch features in the embossing tool.

Generally, the embossing tool is formed by a process comprising three (3) primary steps. First, inductively coupled plasma etching is used to create columnar etch pits in a photoresist-coated substrate, preferably silicon, wherein the columnar etch pits have a high aspect ratio. Second, the shape of the columnar etch pits is altered using reactive ion etching to create more pointed obelisk or pyramidal features, thereby forming etch features. Third, a metal is electroformed over the etch features to create the embossing tool. Preferably, the silicon substrate is rinsed after the reactive ion etching and a conductive layer is vapor deposited over the etch features to facilitate the electroforming step. After electroforming, the silicon substrate is dissolved in a hot potassium hydroxide (POH) solution.

The embossing tool is then used to create high aspect ratio microstructures in an optical coating, such as a polymer sheet, by pressing the embossing tool against the optical coating. Accordingly, the negative image of the etch features in the embossing tool is created in the optical coating. As a result, a relatively low cost embossing tool for forming high aspect ratio microstructures is provided wherein the microstructures are capable of low reflectivity at high incidence angles in addition to a graded index of refraction in both the infrared and visible wavelength regions.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a silicon substrate after an inductively coupled plasma etch process step in accordance with the present invention;

FIG. 2 is a side view of a silicon substrate after a reactive ion etch process step in accordance with the present invention;

FIG. 3 is a side view of a silicon substrate after a rinse step in accordance with the present invention;

FIG. 4 is a side view of a silicon substrate after a metal electroforming step in accordance with the present invention;

FIG. 5 is a side view of an embossing tool in accordance with the present invention; and

FIG. 6 is a side view of an optical coating having a high aspect ratio microstructure in accordance with the present invention.

### DETAILED DESCRIPTION OF THE PREFERRED EMBODIMENTS

The following description of the preferred embodiments is merely exemplary in nature and is in no way intended to limit the invention, its application, or uses.

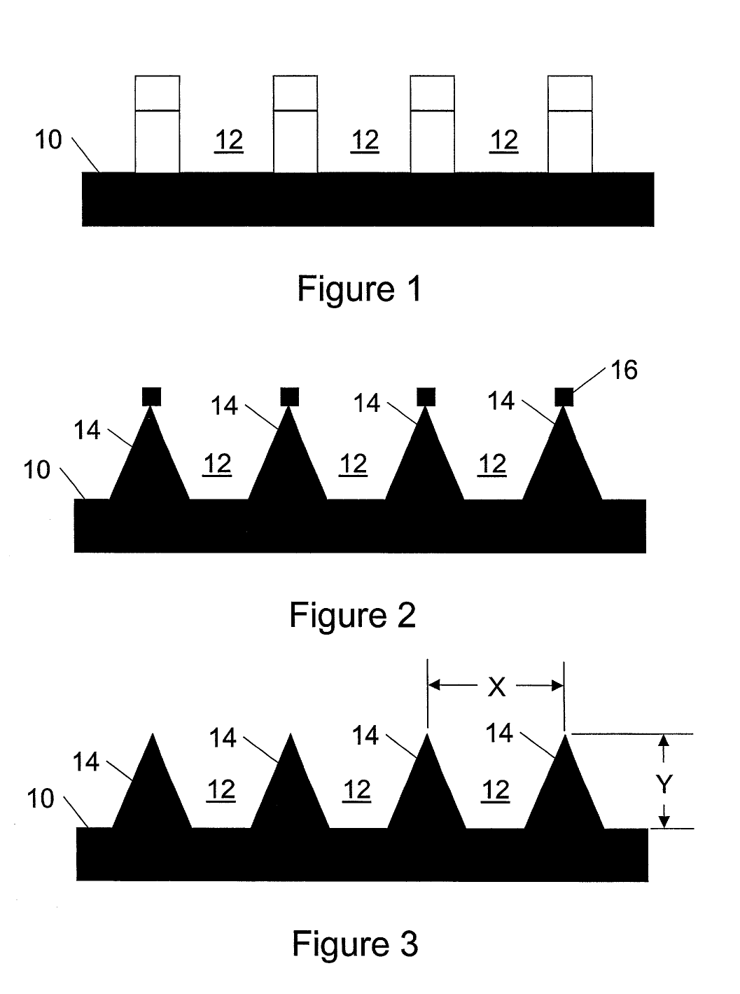

Referring to the drawings, a process for forming a high aspect ratio embossing tool and microstructures therefrom is illustrated generally at each process step. Accordingly, FIG. 1 illustrates the first process step, wherein a substrate 10 is etched using an anisotropic reactive ion etching process, preferably inductively coupled plasma, to generate a plurality of high aspect ratio columnar pits 12. Preferably, the substrate 10 is silicon, and the sizes of the columnar pits may be varied according to the specific operating requirements of the optical coating. Therefore, the illustration of columnar pits 12 having generally the same size and equal spacing shall not be construed as limiting the scope of the present invention.

Referring to FIG. 2, the second process step involves further etching the photomask 12 into relatively pointed obelisks, thereby forming etch features 14. The etching for the second process step is preferably an isotropic etch process, such as reactive ion etching or liquid etching. As shown, the columnar pits 12 are altered into relatively pointed obelisks by the second etch process to form the etch features 14, in addition to the residual tips 16.

Referring to FIG. 3, the substrate 10 is next subjected to a rinse process, wherein the residual tips 16 are removed from the etch features 14. As shown, the etch features 14 comprise a high aspect ratio, which is preferably greater than approximately 5 to 1. The aspect ratio as used herein is defined as the dimension Y divided by the dimension X as illustrated. Further, the substrate 10 is preferably coated with a conductive layer using vapor depositing to facilitate additional process steps as described in greater detail below.

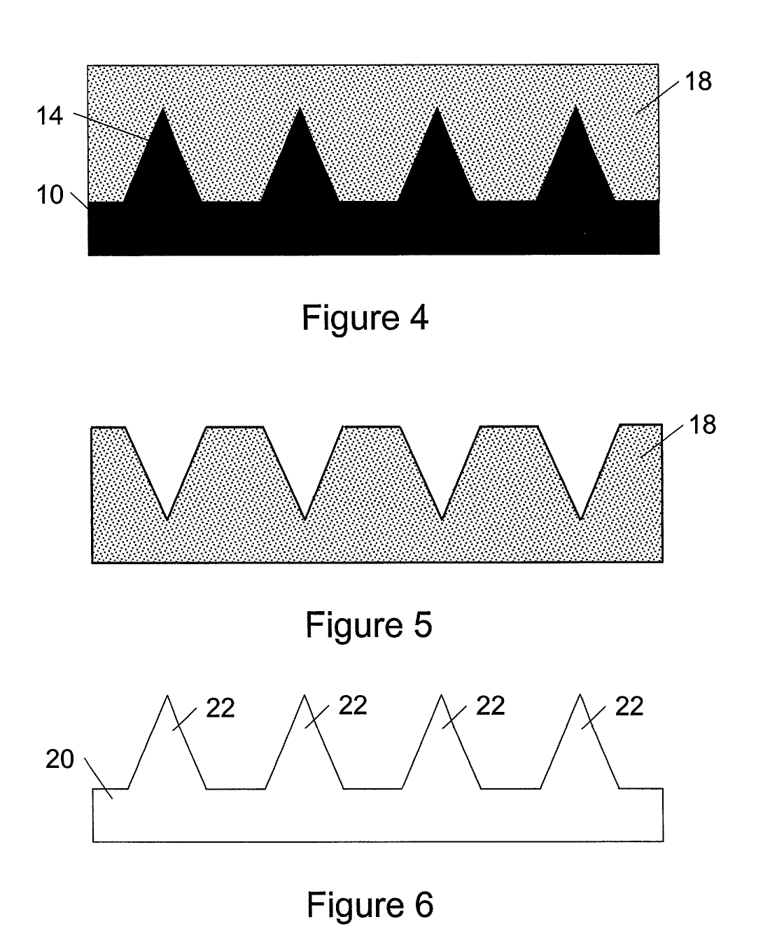

Referring now to FIG. 4, a metal is electroformed over the etch features 14 to form an embossing tool 18. As shown, the embossing tool comprises a negative image of the etch features 14 and is freed by dissolving the substrate 10 as shown in FIG. 5 to be further used in generating an optical coating with high aspect ratio microstructures.

To generate an optical coating with a high aspect ratio microstructure as shown in FIG. 6, the embossing tool 18 is generally pressed against the optical coating 20 to form the microstructure 22. As illustrated, the microstructure 22 is a negative image of the embossing tool surface, and is thus approximately the same image as the etch features 14 on the photomask 10. Accordingly, a relatively low cost embossing tool is provided to create a high aspect ratio microstructure 22 in an optical coating 20 for improved optical performance.

The description of the invention is merely exemplary in nature and, thus, variations that do not depart from the substance of the invention are intended to be within the scope of the invention. Such variations are not to be regarded as a departure from the spirit and scope of the invention.

What is claimed is:

1. A tool for embossing high aspect ratio microstructures in an optical coating comprising:
a plurality of high aspect ratio etch features,
wherein the high aspect ratio etch features are pressed against an optical coating to form a high aspect ratio microstructure.

2. The tool of claim 1, wherein the tool is fabricated from a metal.

3. The tool of claim 2, wherein the metal is electroformed over a substrate.

4. The tool of claim 1, wherein the aspect ratio is greater than approximately 5 to 1.

5. A tool for embossing high aspect ratio microstructures made by the process of:
(a) etching a plurality of high aspect ratio columnar pits in a substrate;
(b) etching the high aspect ratio columnar pits into relatively pointed obelisks, thereby forming etch features; and
(c) electroforming a metal on the etch features.

6. The method of claim 5, wherein the etching of high aspect ratio columnar pits further comprises inductively coupled plasma etching.

7. The method of claim 5, wherein the etching of high aspect ratio columnar pits further comprises anisotropic reactive ion etching.

8. The method of claim 5, wherein the etching of relatively pointed obelisks further comprises isotropic reactive ion etching.

9. The method of claim 5, wherein the etching of relatively pointed obelisks further comprises isotropic liquid etching.

10. The method of claim 5, wherein the substrate is silicon.

11. The method of claim 5 further comprising the step of vapor depositing a conductive layer on the substrate before electroforming a metal on the etch features.

12. The method of claim 5 further comprising the step of rinsing the substrate after the forming of etch features.

13. The method of claim 5, wherein the aspect ratio is approximately greater than 5 to 1.

14. A tool for embossing high aspect ratio microstructures in an optical coating made by the process of:
(a) inductively coupled plasma etching a plurality of high aspect ratio columnar pits in a silicon substrate;
(b) reactive ion etching the high aspect ratio columnar pits into relatively pointed obelisks, thereby forming etch features;
(c) rinsing the silicon substrate;
(d) vapor depositing a conductive layer on the silicon substrate; and
(e) electroforming a metal on the etch features.

15. The process of claim 14, wherein the aspect ratio is greater than 5 to 1.
